(19) United States
(12) Patent Application Publication
(10) Pub. No.: US 2026/0285271 A1
(43) Pub. Date: Sep. 24, 2026

(54) VEHICLE BRAKE CONTROL DEVICE

(71) Applicant: SUBARU CORPORATION, Tokyo (JP)

(72) Inventors: Harunobu HORIGUCHI, Tokyo (JP); Yoshiyuki TANAKA, Tokyo (JP)

(21) Appl. No.: 19/453,626

(22) Filed: Jan. 20, 2026

(30) Foreign Application Priority Data
Feb. 5, 2025 (JP) 2025-017611

(51) Int. Cl. B60T 8/1761; B60T 8/171; B60T 8/172; B60T 8/58

(52) U.S. Cl. CPC B60T 8/17616; B60T 8/171; B60T 8/172; B60T 8/58; B60T 2210/14; B60T 2240/02; B60T 2240/06; B60T 2250/04

(57) ABSTRACT

A vehicle brake control device includes: a ground contact load detector that detects a ground contact load of a wheel; a vehicle body speed detector that detects a vehicle body speed; a wheel speed detector that detects a wheel speed; and a brake controller that calculates a wheel slip ratio based on the detected speeds, and executes anti-lock braking system (ABS) control when the slip ratio exceeds a threshold. The brake controller includes: a first determiner that determines whether a reduction in brake hydraulic pressure during the ABS control is a first reduction; a first change amount calculator that calculates an amount of change in the ground contact load when the reduction is determined as the first reduction; a second determiner that determines whether the amount of change exceeds an allowable amount; and a first hydraulic pressure maintainer that maintains the brake hydraulic pressure when the allowable amount is exceeded.

### CROSS-REFERENCE TO RELATED APPLICATIONS

The present application claims priority from Japanese Patent Application No. 2025-017611 filed on Feb. 5, 2025, the entire contents of which are hereby incorporated by reference.

### BACKGROUND

The disclosure relates to a vehicle brake control device.

Many vehicles have conventionally been equipped with an anti-lock braking system (ABS). In ABS control, when a wheel tends to lock due to a braking operation of a driver who drives the vehicle, the brake hydraulic pressure supplied to the wheel that tends to lock is reduced. By reducing the brake hydraulic pressure of the wheel that tends to lock, the braking force applied to that wheel is weakened. As a result, slippage between the wheel and the road surface (wheel slip) due to the wheel lock is avoided.

For example, in the ABS control disclosed in Japanese Unexamined Patent Application Publication (JP-A) No. 2019-122055, the ABS controller, upon detecting that the driver has depressed the brake pedal, calculates the wheel slip ratio and estimates a friction coefficient μ of the road surface. Next, the ABS controller sets an ABS activation threshold based on the road surface μ. Then, when no ABS control has yet been executed and the wheel slip ratio is determined to be greater than or equal to the ABS activation threshold, the ABS controller performs a brake hydraulic pressure reduction process.

### SUMMARY

An aspect of the disclosure provides a vehicle brake control device including a ground contact load detector, a vehicle body speed detector, a wheel speed detector, and a brake controller. The ground contact load detector is configured to detect a ground contact load of a wheel of a vehicle. The vehicle body speed detector is configured to detect a vehicle body speed of the vehicle. The wheel speed detector is configured to detect a wheel speed of the wheel. The brake controller is configured to calculate a wheel slip ratio based on the vehicle body speed detected by the vehicle body speed detector and the wheel speed detected by the wheel speed detector, and cause anti-lock braking system control to be executed when the wheel slip ratio exceeds a first threshold regarding activation of the anti-lock braking system control. The brake controller includes a first determiner, a first change amount calculator, a second determiner, and a first hydraulic pressure maintainer. The first determiner is configured to determine whether a reduction in brake hydraulic pressure during execution of the anti-lock braking system control is a first reduction. The first change amount calculator is configured to calculate an amount of change in the ground contact load detected by the ground contact load detector when the first determiner determines that the reduction in the brake hydraulic pressure is the first reduction. The second determiner is configured to determine whether the amount of change in the ground contact load calculated by the first change amount calculator exceeds an allowable load change amount. The first hydraulic pressure maintainer is configured to cause the brake hydraulic pressure to be maintained when the second determiner determines that the amount of change in the ground contact load exceeds the allowable load change amount.

An aspect of the disclosure provides a vehicle brake control device including a ground contact load, a vehicle body speed detector, a wheel speed detector, and circuitry. The ground contact load detector includes a sensor and is configured to detect a ground contact load of a wheel of a vehicle. The vehicle body speed detector includes a sensor and is configured to detect a vehicle body speed of the vehicle. The wheel speed detector includes a sensor and is configured to detect a wheel speed of the wheel. The circuitry is configured to calculate a wheel slip ratio based on the vehicle body speed detected by the vehicle body speed detector and the wheel speed detected by the wheel speed detector, and cause anti-lock braking system control to be executed when the wheel slip ratio exceeds a threshold regarding activation of the anti-lock braking system control. The circuitry is configured to determine whether a reduction in brake hydraulic pressure during execution of the anti-lock braking system control is a first reduction. The circuitry is configured to calculate an amount of change in the ground contact load detected by the ground contact load detector when it is determined that the reduction in the brake hydraulic pressure is the first reduction. The circuitry is configured to determine whether the calculated amount of change in the ground contact load exceeds an allowable load change amount. The circuitry is configured to cause the brake hydraulic pressure to be maintained when it is determined the amount of change in the ground contact load exceeds the allowable load change amount.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a side view of a vehicle equipped with a brake control device;

FIG. 2 is a schematic configuration diagram of the brake control device;

FIG. 3A is a flowchart (part 1) illustrating a brake hydraulic pressure control routine during ABS operation;

FIG. 3B is a flowchart (part 2) illustrating the brake hydraulic pressure control routine during ABS operation; and

FIG. 4 is a time chart illustrating changes in wheel speed, ground contact load, wheel braking force, and brake hydraulic pressure during ABS operation.

### DETAILED DESCRIPTION

By the way, each wheel is supported by a suspension. The vertical stroke of the suspension is defined by the geometric arrangement (geometry) of link mechanisms and the like. As disclosed in JP-A No. 2019-122055, in ABS control, when the ABS operates for the first time, the brake hydraulic pressure is reduced to decrease the wheel braking force and thereby reduce wheel slip.

When the wheel braking force is reduced by ABS control, the wheel's ground contact load may increase due to the suspension geometry. This ground contact load is the load that presses the wheel against the road surface. When the ground contact load increases, the wheel braking force also increases, as understood from the following relationship: F=μN (where F: wheel braking force, μ: friction coefficient, and N: ground contact load) As a result, wheel slip is not reduced, and the ABS controller further reduces the brake hydraulic pressure in order to decrease the braking force applied to the wheel.

However, it is conceivable that, when the ABS controller further reduces the brake hydraulic pressure, the wheel's ground contact load may increase even more. Then, when the wheel slip subsides as a result of the reduction in the wheel speed due to the continuous reduction in the brake hydraulic pressure, the ABS controller causes the brake hydraulic pressure to be increased.

When the ABS controller attempts to increase the brake hydraulic pressure, the brake hydraulic pressure has already been continuously reduced. Therefore, it takes time for the braking force applied to the wheel to be restored, and the braking distance may increase.

It is desirable to provide a vehicle brake control device that, with ABS control, can promptly reduce wheel slip and shorten the braking distance even if the ground contact load that presses the wheel against the road surface increases due to the suspension geometry when the brake hydraulic pressure is reduced.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

Note that, in the present embodiment, rear wheels Rw are used as the drive wheels, and the ABS control for these rear wheels Rw will be described.

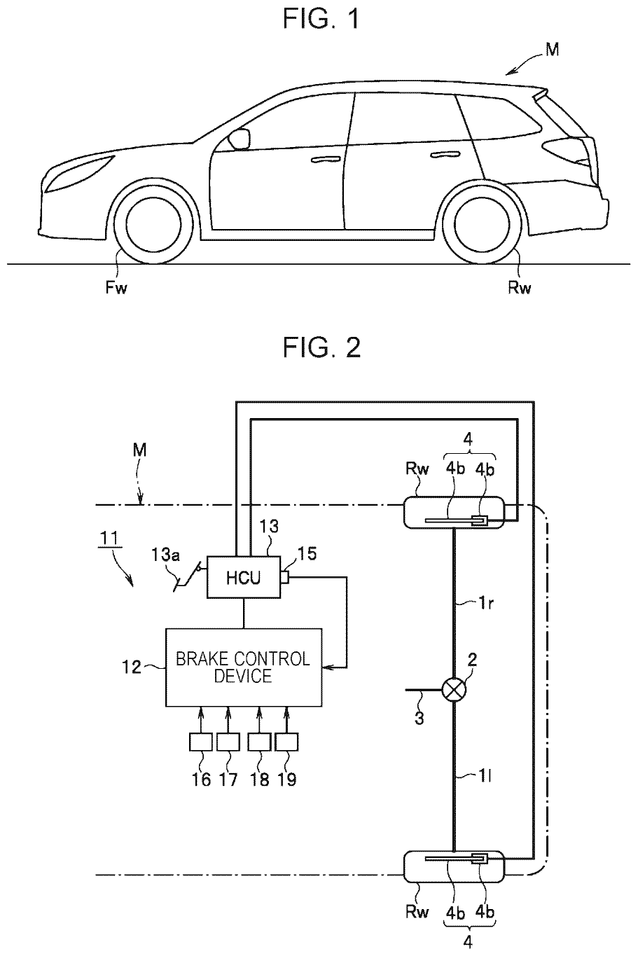

Front wheels Fw and rear wheels Rw of a vehicle M illustrated in FIG. 1 are supported by known suspension devices. The suspension devices support the front wheels Fw and rear wheels Rw so that they can stroke vertically with respect to the vehicle body. The stroke trajectory of the suspension devices is defined by their geometry. Note that the vehicle M of the present embodiment is a four-wheel-drive vehicle or a rear-wheel-drive vehicle.

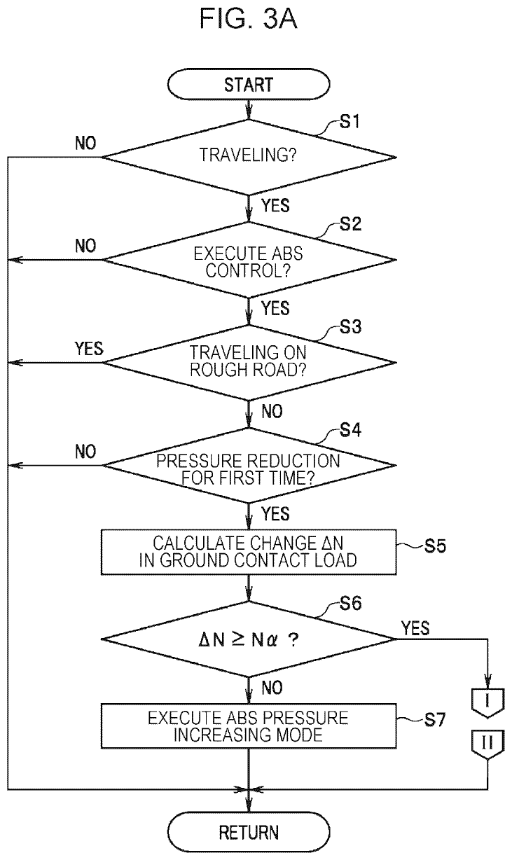

As illustrated in FIG. 2, drive shafts 1l and 1r extending from the left and right rear wheels Rw are coupled to the output side of a differential device 2. An output shaft 3 from a power unit (not illustrated) is continuously disposed on the input side of the differential device 2. The power unit includes a drive source such as an engine or an electric motor, as well as a transmission. Additionally, disc brakes 4 are provided for the respective rear wheels Rw. Each of the disc brakes 4 includes a disc rotor 4a, which is fixed to and rotates integrally with the corresponding one of the left and right rear wheel Rw, and a caliper 4b, which is fixed to the vehicle body and configured to clamp the disc rotor 4a.

The vehicle M is equipped with a brake control device 11. The brake control device 11 has a brake control unit 12, serving as a brake controller, and a brake hydraulic circuit (HCU) 13. The brake control unit 12 executes ABS control.

The brake control unit 12 is composed of a microcontroller. The microcontroller includes a central processing unit (CPU), random-access memory (RAM), read-only memory (ROM), a non-transitory tangible recording medium (flash memory or electrically erasable programmable read-only memory (EEPROM)), and peripheral devices. The RAM of the microcontroller is provided as a work area for the CPU and temporarily stores various data used by the CPU. Additionally, the ROM stores programs and fixed data necessary for the CPU to execute various processes. Note that the CPU may also be referred to as a microprocessor (MPU) or a processor. Furthermore, in place of the CPU, a graphics processing unit (GPU) or a graph streaming processor (GSP) may be used. Alternatively, a combination of CPU, GPU, and GSP may be selectively employed.

Additionally, the output side of the HCU 13 is mechanically coupled to the calipers 4b of the disc brakes 4 via hydraulic lines. Normally, the HCU 13 supplies brake hydraulic pressure to the calipers 4b in accordance with the amount of depression of a brake pedal 13a depressed by the driver. The calipers 4b then press the brake pads against the disc rotors 4a with a force corresponding to the brake hydraulic pressure, thereby generating a wheel braking force.

The input side of the brake control unit 12 is coupled to a brake hydraulic pressure sensor 15, wheel speed sensors 16 as a wheel speed detector, a vehicle body speed sensor 17 as a vehicle body speed detector, ground contact load sensors 18 as a ground contact load detector, and a brake switch 19. The brake hydraulic pressure sensor 15 detects the brake hydraulic pressure supplied to the calipers 4b. The wheel speed sensors 16 detect the respective wheel speeds Vw of the left and right rear wheels Rw.

The vehicle body speed sensor 17 calculates the vehicle body speed Vv from the amount of displacement of the vehicle M. The vehicle body speed sensor 17 detects the vehicle body speed, for example, from the amount of displacement per unit time based on the position information obtained from global navigation satellite system (GNSS) satellites. Alternatively, the vehicle body speed sensor 17 detects the vehicle body speed based on changes in acceleration detected by a longitudinal acceleration sensor. Alternatively, the vehicle body speed sensor 17 detects the vehicle body speed from the amount of displacement per unit time of a specific point of interest based on information on the specific point of interest, detected by a forward recognition unit such as a camera.

The ground contact loads N of the rear wheels Rw are respectively detected by the ground contact load sensors 18. The brake switch 19 detects the amount of depression of the brake pedal 13a by the driver. The brake switch 19 outputs an ON signal when the brake pedal 13a is depressed.

The brake control unit 12 calculates a wheel slip ratio λRw of each of the rear wheels Rw. This wheel slip ratio is calculated using the following:

$$wheel slip ratio = ( vehicle body speed - wheel speed ) / vehicle body speed$$

The brake control unit 12 then initiates ABS control when the wheel slip ratio λRw exceeds an ABS activation threshold. In the ABS control performed by the brake control unit 12, the brake hydraulic pressure supplied to the calipers 4b is reduced in a predetermined manner to decrease the wheel braking force and thereby reduce wheel slip.

At that time, after the first pressure reduction by the ABS control, the brake control unit 12 causes the brake hydraulic pressure to be maintained. By maintaining the brake hydraulic pressure, changes in the ground contact load of each of the rear wheels Rw caused by the suspension geometry are suppressed. As a result, wheel slip can be promptly stabilized, and the braking distance can be shortened.

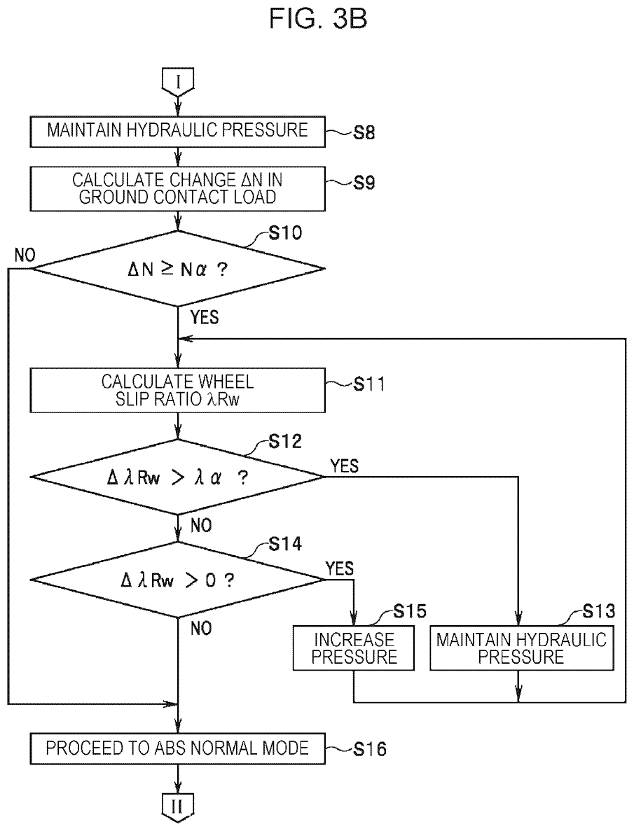

During ABS control performed by the brake control unit 12, the control of the brake hydraulic pressure after the first pressure reduction is, in one example, processed in accordance with a brake hydraulic pressure routine during ABS control, which is illustrated in FIGS. 3A and 3B.

The brake control unit 12 first checks whether the vehicle M is currently traveling (step S1). Whether the vehicle M is currently traveling is determined by, for example, comparing the vehicle body speed detected by the vehicle body speed sensor 17 with a preset threshold speed (e.g., 10 to 15 [Km/h]). Then, when the brake control unit 12 determines that the vehicle M is currently traveling (YES), it checks whether ABS control is being executed (step S2). When the brake control unit 12 determines that the vehicle M is stopped (NO), it exits the routine. Whether ABS control is being executed is determined, for example, depending on whether an ABS control signal is being output from the brake control unit 12 to the HCU 13.

When the brake control unit 12 determines that ABS control is being executed (step S2: YES), it checks whether the vehicle M is currently traveling on a rough road (step S3). The processing in step S3 corresponds to a rough road traveling determiner of the disclosure. When the brake control unit 12 determines that ABS control is not being executed (step S2: NO), it exits the routine. The brake control unit 12 determines whether the vehicle M is currently traveling on a rough road based on, for example, an acceleration calculated from the wheel speed Vw detected by one of the wheel speed sensors 16 of the left and right rear wheels Rw. Alternatively, the brake control unit 12 determines whether the vehicle M is currently traveling on a rough road from, for example, changes in the ground contact load N detected by the corresponding ground contact load sensor 18.

Then, when either the change in acceleration or the change in the ground contact load N is large, the brake control unit 12 determines that the vehicle M is currently traveling on a rough road.

When the brake control unit 12 determines that the vehicle M is traveling on a rough road (YES), it exits the routine. When the vehicle M is traveling on a rough road such as a gravel road, the suspensions of the four wheels operate independently of each other. Under such conditions, it is not practical to control the brake hydraulic pressure in accordance with the motion of the suspensions.

When the brake control unit 12 determines that the vehicle M is not traveling on a rough road (NO), it checks whether the start of pressure reduction by the ABS control is the first reduction (first time) (step S4). The processing in step S4 corresponds to a first determiner of the disclosure. When the brake control unit 12 determines that the start of pressure reduction by the ABS control is the first reduction (YES), it causes the routine to proceed to step S5. Alternatively, when the brake control unit 12 determines that the start of pressure reduction by the ABS control is not the first reduction (NO), it exits the routine.

Upon proceeding to step S5, the brake control unit 12 calculates the amount of change ΔN in the ground contact load N for each calculation cycle. The processing in step S5 corresponds to a first change amount calculator of the disclosure. The ground contact load N is detected by the corresponding ground contact load sensor 18. The ground contact load sensor 18 is, for example, a load cell provided on each of the rear wheels Rw. Alternatively, the ground contact load sensor 18 may be a height sensor that detects the distance between the vehicle body on the corresponding rear wheel Rw side and the road surface. The amount of change ΔN in the ground contact load N of each rear wheel Rw can be estimated to increase or decrease in proportion to the change in the ground clearance on each rear wheel Rw side.

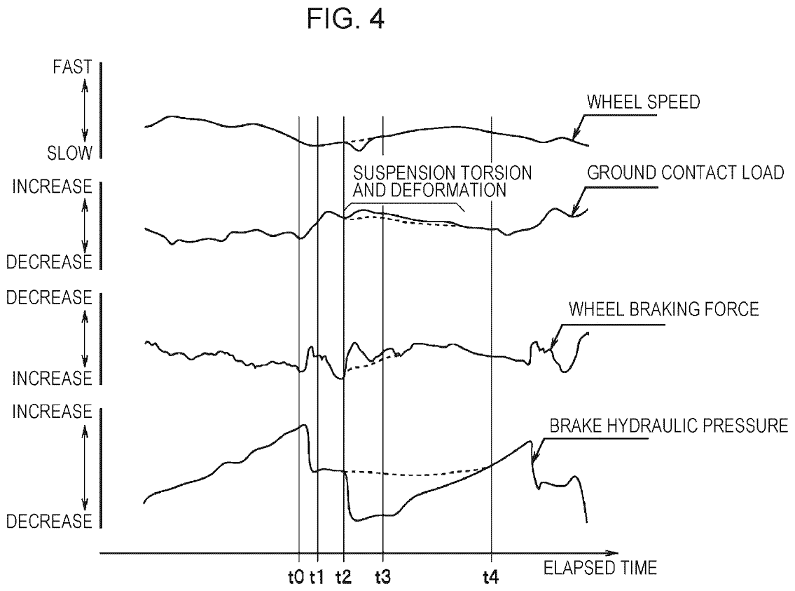

FIG. 4 is a time chart illustrating changes in wheel speed, rear wheel Rw ground contact load, wheel braking force, and brake hydraulic pressure when the driver depresses the brake pedal 13a and then ABS control intervenes. FIG. 4 represents measured values obtained from experiments. Here, the wheel speed is a measured value obtained by each wheel speed sensor 16. The ground contact load and wheel braking force are measured values obtained using a six-axis force sensor mounted inside each rear wheel Rw. The brake hydraulic pressure is a measured value obtained by the brake hydraulic pressure sensor 15.

As indicated in the time before the elapsed time t₀ in FIG. 4, when the driver depresses the brake pedal 13a, the brake hydraulic pressure increases, the wheel braking force is applied to each rear wheel Rw, and the wheel speed decreases. When the wheel braking force is applied to each rear wheel Rw, torsion occurs in the suspension components due to the vehicle body's inertial forces, and further, deformation occurs in the rubber bushings that support the link mechanisms of the suspension. Subsequently, when the wheel slip ratio λRw exceeds the ABS activation threshold, as indicated in the elapsed time t₀-t₁ in FIG. 4, the brake control unit 12 activates ABS control. In the ABS control for the first time, the brake hydraulic pressure is reduced in a predetermined manner.

As indicated in the elapsed time t₀-t₁ in FIG. 4, when the brake hydraulic pressure is reduced due to the activation of ABS control, the torsion of the suspension and the deformation of the rubber bushings are gradually released. As the torsion of the suspension and the deformation of the rubber bushings are released, the suspension may push the rear wheel Rw against the ground, causing an increase in the ground contact load of the rear wheel Rw. FIG. 4 illustrates a state in which this increase in the ground contact load continues until the elapsed time t₃.

As indicated in the elapsed time t₁-t₂, when the ground contact load increases, the wheel braking force increases even though the brake hydraulic pressure remains constant. Then, as indicated in the elapsed time t₂-t₃, the ABS control executed by the brake control unit 12 further causes the brake hydraulic pressure to be reduced. However, because the ground contact load increases as the stresses accumulated in the torsion of the suspension and the deformation of the rubber bushings are released, a mismatch arises between the change in the brake hydraulic pressure and the change in the wheel braking force. When such a mismatch arises between the change in the brake hydraulic pressure and the change in the wheel braking force, the wheel speed temporarily decreases, causing wheel slip. As a result, after the elapsed time t₃, even when the ground contact load of the rear wheel Rw returns to normal, the increase in the brake hydraulic pressure is delayed in the ABS control executed by the brake control unit 12. This also causes a delay in the restoration of the wheel braking force.

Next, the brake control unit 12 compares the amount of change ΔN in the ground contact load N with a preset allowable load change amount Nα (step S6). The processing in step S6 corresponds to a second determiner of the disclosure. Then, when the brake control unit 12 determines that the amount of change ΔN is less than the allowable load change amount Nα (NO), it executes an ABS pressure increasing mode (step S7), and exits the routine. When the amount of change ΔN is less than the allowable load change amount Nα, it is estimated that the torsion and deformation occurring in the suspension are small.

Additionally, when it is determined that the amount of change ΔN has increased to be greater than or equal to the allowable load change amount Nα (YES), the brake control unit 12 causes the current brake hydraulic pressure to be maintained (step S8). The processing in step S8 corresponds to a first hydraulic pressure maintainer of the disclosure. As indicated in the elapsed time t2-t3 in FIG. 4, by continuing the state in which the brake hydraulic pressure is maintained, an abrupt increase in the ground contact load N is suppressed. This suppresses the decrease in the wheel braking force and also suppresses the decrease in the wheel speed.

Then, the brake control unit 12 again calculates the amount of change ΔN in the ground contact load N (step S9). The processing in step S9 corresponds to a second change amount calculator of the disclosure. Then, the brake control unit 12 again compares this amount of change ΔN with the allowable load change amount Nα (step S10). The processing in step S10 corresponds to a fifth determiner of the disclosure. When the brake control unit 12 determines that the amount of change ΔN falls within the allowable load change amount Nα (NO), it causes the routine to jump to step S16. Alternatively, when the brake control unit 12 determines that the amount of change ΔN still exceeds the allowable load change amount Nα (YES), it proceeds to step S11. When the amount of change ΔN still exceeds the allowable load change amount Nα, it can be estimated that the effects of torsion and deformation of the suspension still remain.

Upon proceeding to step S11, the brake control unit 12 calculates the wheel slip ratio λRw. The wheel slip ratio λRw is calculated based on the vehicle body speed Vv detected by the vehicle body speed sensor 17 and the wheel speed Vw detected by the wheel speed sensor 16, using the following equation:

$$λ Rw = ( Vv - Vw ) / Vv$$

Next, the brake control unit 12 compares this calculated wheel slip ratio λRw with the previously calculated wheel slip ratio λRw to calculate the difference (slip ratio difference) ΔλRw.

The brake control unit 12 then compares the slip ratio difference ΔλRw with an allowable increase determination threshold λα (step S12). The processing in step S12 corresponds to a third determiner of the disclosure. This allowable increase determination threshold λα is a threshold used to determine whether the amount of increase in the wheel slip ratio λRw is small.

When the brake control unit 12 determines that ΔλRw>λα (YES), it causes the current brake hydraulic pressure to be maintained (step S13), and causes the routine to return to step S11. The processing in step S13 corresponds to a second hydraulic pressure maintainer of the disclosure. By the way, in the state where the current brake hydraulic pressure is being maintained, it is possible that torsion and deformation still remain in the suspension. Therefore, even when it is determined that the slip ratio difference ΔλRw exceeds the allowable increase determination threshold λα, if the brake hydraulic pressure is immediately reduced, the torsion and deformation may be further released, resulting in a possible increase in the ground contact load, as indicated by the solid line in the elapsed time t₃-t₄ in FIG. 4. Therefore, the brake control unit 12 causes the brake hydraulic pressure to be maintained, as indicated by the dashed line in the elapsed time t3-t4 in FIG. 4, thereby suppressing an unnecessary reduction in the brake hydraulic pressure.

Furthermore, as a result of the brake control unit 12 continuously reducing the brake hydraulic pressure, there is a possibility that the road surface μ may be erroneously estimated to be lower than it actually is. If the road surface μ is erroneously estimated to be a low value, the gradient used to increase the brake hydraulic pressure by the ABS control may be limited. Therefore, in step S13, the brake hydraulic pressure is first maintained.

Alternatively, when the brake control unit 12 determines that ΔλRw≤λα (NO), it checks whether the slip ratio difference ΔλRw has slightly increased (step S14). The processing in step S14 corresponds to a fourth determiner of the disclosure. Then, when the brake control unit 12 determines that, while ΔλRw>0, the brake hydraulic pressure has slightly increased (YES), it increases the brake hydraulic pressure (step S15) and causes the routine to return to step S11. The processing in step S15 corresponds to a hydraulic pressure increasing unit of the disclosure. If the slip ratio difference ΔλRw has only slightly increased, it can be estimated that the torsion and deformation of the suspension are released. Therefore, the brake hydraulic pressure is increased so as to cause the brake hydraulic pressure to return to the so-called ABS control at an early stage.

Additionally, when the ground contact load N increases after the brake control unit 12 reduces the brake hydraulic pressure, as in the processing in steps S13 and S15, it maintains or increases the brake hydraulic pressure according to the difference ΔλRw of the wheel slip ratio λRw. Accordingly, it is possible to check whether the torsion and deformation of the suspension have been released. Then, when it is estimated that the torsion and deformation of the suspension have been released, the brake hydraulic pressure can be promptly increased after the wheel slip ratio λRw has converged.

In contrast, when the brake control unit 12 determines that, when ΔλRw≤0, the change in the wheel slip ratio λRw is small (NO), it causes the routine to proceed to step S16. Upon proceeding from step S10 or step S14 to step S16, the brake control unit 12 causes the ABS control to transition to the normal mode and exits the routine.

As described above, in the present embodiment, after the brake control unit 12 executes ABS control and then starts the first reduction in brake hydraulic pressure, it calculates the amount of change ΔN in the ground contact load N of the rear wheel Rw (step S6). Even if the brake control unit 12 determines that the amount of change ΔN has increased to be greater than or equal to the allowable load change amount Nα, it causes the brake hydraulic pressure to be maintained without being reduced (step S8). Accordingly, the torsion and deformation accumulated in the suspension are less likely to be released instantaneously. As a result, the increase in the wheel braking force F (=μN) due to the increase in the ground contact load N can be suppressed, and an unnecessary reduction in the brake hydraulic pressure can be suppressed.

Thereafter, the brake control unit 12 maintains the state in which the brake hydraulic pressure is maintained without being reduced even if the difference ΔλRw of the wheel slip ratio λRw exceeds the allowable increase determination threshold λα. Accordingly, even if some torsion or deformation accumulated in the suspension remains unreleased, it is not released instantaneously, which suppresses an unnecessary reduction in brake hydraulic pressure caused by an increase in the ground contact load N.

As a result, in the ABS control, the wheel slip ratio can be promptly reduced, thereby making it possible to shorten the braking distance.

Note that the disclosure is not limited to the above-described embodiment. For example, although ABS control for the rear wheels Rw has been described in the embodiment, it goes without saying that the disclosure is also applicable to the front wheels Fw.

According to the disclosure, when the reduction in the brake hydraulic pressure during the execution of ABS control is the first reduction and the amount of change in the ground contact load exceeds the allowable load change amount, the brake hydraulic pressure is caused to be maintained. As a result, even when the reduction in the brake hydraulic pressure by the ABS control causes an increase in the ground contact load pressing the wheel against the road surface due to suspension geometry, the wheel slip can be promptly reduced, thereby making it possible to shorten the braking distance.

The brake control unit 12 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the brake control unit 12. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A vehicle brake control device comprising:
a ground contact load detector configured to detect a ground contact load of a wheel of a vehicle;
a vehicle body speed detector configured to detect a vehicle body speed of the vehicle;
a wheel speed detector configured to detect a wheel speed of the wheel; and
a brake controller configured to calculate a wheel slip ratio based on the vehicle body speed detected by the vehicle body speed detector and the wheel speed detected by the wheel speed detector, and cause anti-lock braking system control to be executed when the wheel slip ratio exceeds a first threshold regarding activation of the anti-lock braking system control,
wherein the brake controller comprises:
a first determiner configured to determine whether a reduction in brake hydraulic pressure during execution of the anti-lock braking system control is a first reduction;
a first change amount calculator configured to calculate an amount of change in the ground contact load detected by the ground contact load detector when the first determiner determines that the reduction in the brake hydraulic pressure is the first reduction;
a second determiner configured to determine whether the amount of change in the ground contact load calculated by the first change amount calculator exceeds an allowable load change amount; and
a first hydraulic pressure maintainer configured to cause the brake hydraulic pressure to be maintained when the second determiner determines that the amount of change in the ground contact load exceeds the allowable load change amount.

2. The vehicle brake control device according to claim 1, wherein the brake controller further comprises:
a third determiner configured to calculate an amount of change in the wheel slip ratio after the first hydraulic pressure maintainer causes the brake hydraulic pressure to be maintained, and determine whether the amount of change exceeds a second threshold regarding allowable increase determination; and
a second hydraulic pressure maintainer configured to further cause the brake hydraulic pressure to be maintained when the third determiner determines that the amount of change in the wheel slip ratio exceeds the second threshold.

3. The vehicle brake control device according to claim 2, wherein the brake controller further comprises:
a fourth determiner configured to determine whether the amount of change in the wheel slip ratio has slightly increased when the third determiner determines that the amount of change in the wheel slip ratio falls within the second threshold; and
a hydraulic pressure increasing unit configured to cause the brake hydraulic pressure to be increased when the fourth determiner determines that the amount of change in the wheel slip ratio has slightly increased.

4. The vehicle brake control device according to claim 2, wherein:
the brake controller further comprises:
a second change amount calculator configured to calculate the amount of change in the ground contact load after the first hydraulic pressure maintainer causes the brake hydraulic pressure to be maintained; and
a fifth determiner configured to determine whether the amount of change in the ground contact load, calculated by the second change amount calculator, exceeds the allowable load change amount, and
when the fifth determiner determines that the amount of change in the ground contact load, calculated by the second change amount calculator, exceeds the allowable load change amount, the third determiner is configured to calculate the amount of change in the wheel slip ratio after the brake hydraulic pressure has been maintained.

5. The vehicle brake control device according to claim 1, wherein:
the brake controller further comprises a rough road traveling determiner configured to determine whether the vehicle is currently traveling on a rough road; and
the first determiner is configured to, when the rough road traveling determiner is configured to determine that the vehicle is not traveling on the rough road, determine whether a reduction in brake hydraulic pressure during execution of the anti-lock braking system control is a first reduction.

6. A vehicle brake control device comprising:
a ground contact load detector comprising a sensor and configured to detect a ground contact load of a wheel of a vehicle;
a vehicle body speed detector comprising a sensor and configured to detect a vehicle body speed of the vehicle;
a wheel speed detector comprising a sensor and configured to detect a wheel speed of the wheel; and
circuitry configured to calculate a wheel slip ratio based on the vehicle body speed detected by the vehicle body speed detector and the wheel speed detected by the wheel speed detector, and cause anti-lock braking system control to be executed when the wheel slip ratio exceeds a threshold regarding activation of the anti-lock braking system control,
wherein the circuitry is configured to:
determine whether a reduction in brake hydraulic pressure during execution of the anti-lock braking system control is a first reduction;
calculate an amount of change in the ground contact load detected by the ground contact load detector when it is determined that the reduction in the brake hydraulic pressure is the first reduction;
determine whether the calculated amount of change in the ground contact load exceeds an allowable load change amount; and
cause the brake hydraulic pressure to be maintained when it is determined the amount of change in the ground contact load exceeds the allowable load change amount.
